(19) United States
(12) Patent Application Publication
(10) Pub. No.: US 2022/0003136 A1
(43) Pub. Date: Jan. 6, 2022

(54) INTERNAL COMBUSTION ENGINE INCLUDING OIL DIPSTICK WITH FIXING BY PERMANENT MAGNET AND SEAL OF OIL DIPSTICK BORE WITH FIXING BY PERMANENT MAGNET

(71) Applicant: DEUTZ Aktiengesellschaft, Koeln (DE)

(72) Inventors: Johannes KLOSTERBERG, Swisttal (DE); Thomas WERNER, Koeln (DE)

(21) Appl. No.: 17/351,360

(22) Filed: Jun. 18, 2021

(30) Foreign Application Priority Data
Jul. 4, 2020 (DE) 102020004046.2

(51) Int. Cl. F01M 11/12; F01M 11/00; F02F 1/24; F16J 15/02

(52) U.S. Cl. CPC F01M 11/12; F01M 11/0004; F01M 2011/0066; F16J 15/02; F01M 2011/0062; F02F 1/24

(57) ABSTRACT

An internal combustion engine includes an oil dipstick fixed by permanent magnet. An oil dipstick bore is sealed by the fixing by the permanent magnet. The internal combustion engine includes at least one crankcase, at least one cylinder head, at least one oil pan and at least one reception element for receiving a stopper and at least one stopper.

This claims priority of German Patent Application DE 10 2020 004 046.2 filed Jul. 4, 2020, which is hereby incorporated herein.

The present disclosure relates to an internal combustion engine including an oil dipstick with fixing by a permanent magnet or a sealing plug of the oil dipstick bore with fixing by at least one permanent magnet.

### BACKGROUND

The oil dipsticks used thus far in internal combustion engines are generally fixed exclusively by the clamping force of -O-rings. Other approaches are clamping with the aid of a form fit. In this case, the area of the screw head is designed in such a way that it latches into a groove or the like. Approaches of the type of a bayonet joint are also known. The latter approaches involving a form fit require for this purpose a particular implementation of the oil dipstick bore or of the oil dipstick guide tube. That is expensive. To fix the oil dipstick merely by the clamping force of O-rings may result in the dipstick falling out due to vibration or increased crankcase internal pressure.

### SUMMARY

An object of the present disclosure is to prevent the above-cited disadvantages and to create an internal combustion engine that includes a safe and cost-effective seal or oil dipstick.

According to the present disclosure, this object is achieved by an internal combustion engine including at least one crankcase, at least one cylinder head, at least one oil pan, and at least one reception element for receiving a stopper and at least one stopper.

A further advantage of the present internal combustion engine is a very simple design of the bore of the crankcase as well as of the head at the oil dipstick.

A stopper or also a plug is an object that is used to tightly seal a hole. The term “Stopfen/Stöpsel” is a noun that is derived from the low and central German verb “stoppen” which means something along the lines of “to stop” or also “to stop the run,” i.e., to block using an obstacle. The seal is intended to prevent a gas or a fluid, for example water or oil, from escaping or penetrating. In contrast to a cap, plugs are pressed into the hole and not used to cover the hole. Since stoppers are intended to tightly seal something, most of them are manufactured from soft materials such as rubber or cork. In this way, it is possible to compress and press them more easily into the somewhat smaller hole. There are, however, also plugs made of glass or wood. In Austria, the cork of a wine bottle is also called “Stöpsel” (or also “Stoppel”), since wooden plugs had been used instead of cork until the end of the 17th century. The Romans had already used cork to close their amphorae, which then would be sealed using pitch, but this technique was later forgotten after the downfall of the Roman Empire. In the North, flax or hemp scraps, which were then sealed with wax, were used for this purpose. In the 15th century, wine was no longer solely traded in barrels, which is how Germans also learned about the French sealing technique using cork bark.

Further applications involve the sealing of test tubes via ground-in plugs in chemistry and the closing off of catheters and infusion tubes in medicine. Ear plugs are also used in loud production facilities to meet regulations with regard to safety at work or at concerts during leisure time activities. The term “Stöpsel” is also used for plugs in the form of an electrical component, such as a cinch plug, for example. Plugs or stoppers are applied in tubs and sinks for the purpose of sealing the outlet.

A permanent magnet is a magnet made from a piece of a hard magnetic material, for example alloys made from iron, cobalt, nickel or certain ferrites. It has and maintains a constant magnetic field, without having to apply electrical power, as is the case with electromagnets. Permanent magnets have one or multiple north and south pole(s) on their surfaces in each case. The first artificial permanent magnetic materials were manufactured by John Canton around 1750. A permanent magnet may be generated in that a magnetic field applies an extensive hysteresis curve (so-called hard magnetic material) to a ferrimagnetic or ferromagnetic material. Early magnetic materials based on iron have resulted in the terms “magnetically hard” and “magnetically soft”: hard, carbon-rich steel may be made permanently magnetic, while less carbon-rich, soft iron may hardly be made permanently magnetic and is therefore better suited for the production of iron cores for electromagnets. A permanent magnet may be demagnetized as a result of a subsiding magnetic alternating field, heating or impact. The form that is best known in everyday life are ferrite magnets, for example as a magnetic clamp or—provided with iron pole shoes—as a closet door lock. A permanent magnet attracts all ferromagnetic materials, such as iron, for example, and ferrimagnetic materials, such as ferrites. Two permanent magnets attract each other via their unlike poles and repel like poles. Rings that are magnetized along their circumference do not have poles and do not apply any forces—they are magnetized, but they are not referred to as permanent magnets. Magnetized layers of magnetic bands, magnetic strips, or hard drives do have poles, but they are not referred to as permanent magnets either. The hysteresis curves of magnetizable, hard magnetic materials are particularly wide in contrast to the illustrated graphic and resemble a rectangle, in which the almost perpendicular curves of the field strength axis intersect at Hc in the case of great field strengths. The illustrated graphic rather shows the hysteresis curve of a soft magnetic material that is present during the recording of the hysteresis curve in a transformer having only a small air gap or in an Epstein frame, for example. In the case of soft magnetic materials, such as sheet metals or ferrites for transformer cores, the hysteresis curve is very narrow and intersects the field strength axis in the case of low field strength values. The energy product, also referred to as BH product, is the entire field energy stored in the magnet. The energy density is the magnetic energy with regard to the volume of the magnet.

The field strength that must be expended to demagnetize the magnet completely (flow density B=0) is where the hysteresis curve and the axis of field strength H intersect. The greater the coercive field strength, the greater is the resistance of the magnet to demagnetization through external fields. While the Curie temperature indicates the point at which the ferromagnetic property of a material disappears, the macroscopic orientation of the Weiss domains and thus the permanent magnetic properties disappear irreversibly already at significantly lower temperatures. This macroscopic orientation at temperatures above the absolute zero point is in general unstable, but in practical use a temperature range, in which the inevitable demagnetization happens slowly and unnoticeably or is essentially determined by mechanical stress, may be indicated for the relevant materials. The flow density that occurs without an external field is referred to as remanence. Its value is readable at the hysteresis curve as the value of B at H=0. Permanent magnets used to be produced from steel. They are, however, very weak and may be demagnetized very easily. Horseshoe magnets are the best-known form. In the case of steel tools, permanent magnetization may also form through plastic mechanical deformation. This is evidence of their mechanical overload. Aluminum-nickel-cobalt (AlNiCo) magnets consist of iron alloys having aluminum, nickel and cobalt as main alloy elements. These materials are employable at up to 500° C., but they have a relatively low energy density and coercive field strength. The remanence is higher than in the case of ferrite magnets. The manufacture takes place with the aid of casting or powder metallurgy processes. They have a good corrosion resistance, but they are breakable and hard. Bismanol is an alloy made of bismuth, manganese, and iron and forms a strong permanent magnetic material as an alloy. Magnets made of magnetically hard ferrites are cost-effective, but relatively weak and they have a maximal operating temperature of 250° C. Typical applications are magnetic clamps and field magnets of DC motors and electrodynamic loudspeakers. Rare-earth magnets, such as neodymium-iron-boron (NdFeB), for example, allow for very strong magnets at acceptable costs. For a long time, the operating temperatures were limited to a maximum of 60° C. to 120° C. In the case of more recent developments using additives such as dysprosium, operating temperatures up to 200° C. are indicated. Samarium-cobalt (SmCo) having a 20% to 25% iron content allows for strong permanent magnets having a high energy density and a high operating temperature. The disadvantage is the high price. A special form among magnetic materials are non-metallic, organic plastics having the properties of permanent magnets, such as the plastic magnetic material PANiCNQ that has ferromagnetic properties at room temperature.

The oil measuring dipstick or dipstick or oil dipstick or a gauge glass show in an internal combustion engine how much oil is still present in the reservoir, for example in the oil pan. The oil level is predefined by the manufacturer and is between a defined minimum and maximum. For the purpose of the measurement, the vehicle including the internal combustion engine should stand on a planar surface and be in a condition as predefined in the user's manual—according to the manual, the oil level is oftentimes to be measured, for example, when the engine is switched off, but at operating temperature. The oil dipstick is to be subsequently pulled out, cleaned and fully reinserted, since oil droplets that fell from the cylinder head onto the dipstick inside the engine might simulate an elevated oil level. The dipstick may now be pulled out again and the oil level read. An oil level above the maximum results in that the crankshaft constantly strikes the oil and thus causes it to foam; the oil foam provides insufficient lubrication and may cause damage. In addition, the foam decelerates the spraying width of the oil, so that the piston running surface is not sufficiently lubricated. Overfilling has yet another disadvantage: If the oil level is too high, important venting bores of the crankcase are covered by the oil level, thus resulting in that excess oil enters the intake system via the crankcase vents and is combusted in the engine. This may result in considerably higher combustion temperatures, afterglow on the surface of the cylinder head and, in the case of gasoline engines, knocking due to premature ignition in the next cycle and thus damage to many components of the engine—up to a total engine failure—and of the catalytic converter. If the oil level is too low, oil must be refilled to prevent the oil pump from sucking in air, which would result in an oil pressure drop. This is signaled via the oil pressure warning light. When same lights up, the engine is already being damaged. This is why, oil level sensors that display an excessively low oil level, even before the oil pressure drops, are installed in some vehicles. The oil pressure warning light is switched from the ignition-switched positive pole of the oil pressure switch to the engine housing as the negative pole. The oil pressure switch is situated in the oil channel behind the pump and downstream from the oil filter. The oil pressure opens the contact. Oil pressure switches of equal dimensions may be available at different switching pressures. Multipole oil pressure switches have additional switches that are potential-neutral with regard to the housing or sensor contacts for oil pressure and oil temperature measurement, or they are integrated into a bus system.

### BRIEF DESCRIPTION OF THE DRAWINGS

The present disclosure is elucidated in greater detail below on the basis of an exemplary embodiment.

FIG. 1a: shows the oil dipstick assembly;

FIG. 1b: shows a sealing stopper including fixing by a permanent magnet;

FIG. 2: shows the oil dipstick assembly including fixing via a magnet in the installed state; and

FIG. 3: shows the sealing stopper including fixing via a magnet in the installed state.

### DETAILED DESCRIPTION

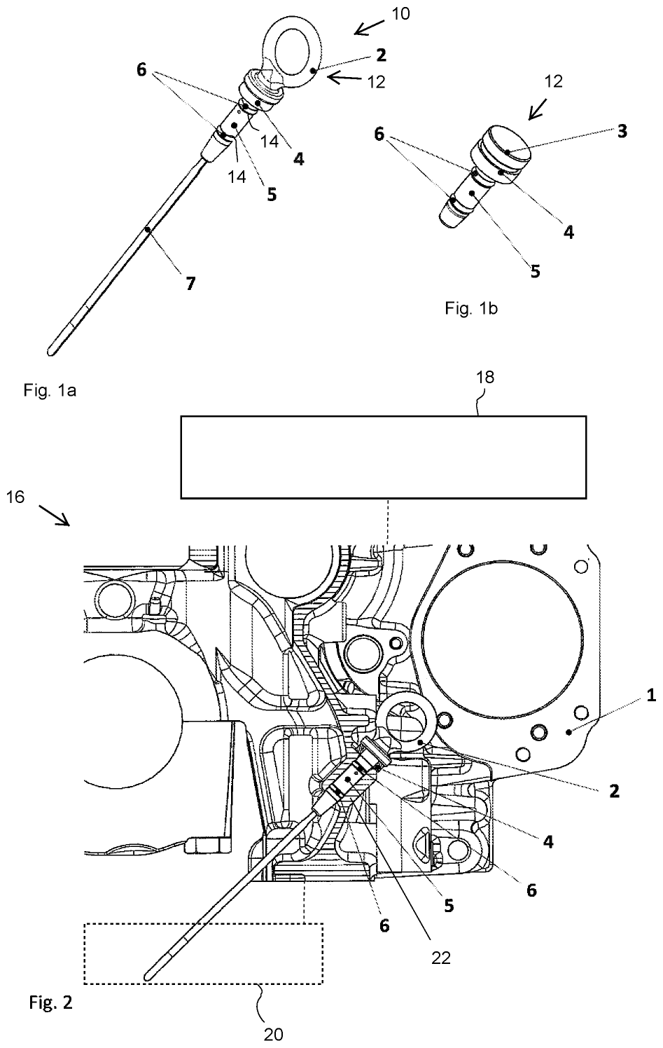

FIG. 1a shows a dipstick assembly 10 includes a stopper 12 and a dipstick 7. FIG. 1b shows a stand-alone view of stopper 12. Stopper 12 includes a head 3 and a cylindrical part 5. Cylindrical part 5 has at least one ring groove 14 for receiving an O-ring 6. O-rings 6 are situated upstream and downstream from the cylindrical part 5 of stopper 12. A head 3 of stopper 5 has a circular design. Head 3 of the stopper 12 is provided with a dipstick head 15 having a ring-shaped element 2.

FIG. 2 shows internal combustion engine 16 including a crankcase 1, a schematically shown cylinder head 18, a schematically shown oil pan 20, stopper 12, a reception element 22 for receiving stopper 12 and dipstick 7 situated at stopper 12. Stopper 12 is designed in such a way that it may be inserted into and fixed at the reception element 16.

The specific embodiment shown in FIG. 1 includes a permanent magnet 4 for fixing the dipstick at crankcase 1. Permanent magnet 4 is situated downstream from the head 5 of stopper 12. The dipstick assembly 10 has a permanent magnet 4 at the stopper head 3. Permanent magnet 4 is in contact with crankcase 1 in the inserted state of the dipstick assembly 10, as is also illustrated in FIG. 2. The dipstick assembly 10 is thereby fixed at crankcase 1 at a force of approximately 5 kg to 10 kg. This is sufficient to fix same for the crankcase inner pressures admissible during operation and the test overpressure at the crankcase during engine inspection and approval. The cylindrical part of stopper 5 includes one or multiple O-ring(s) 6 for the purpose of sealing toward the oil chamber.

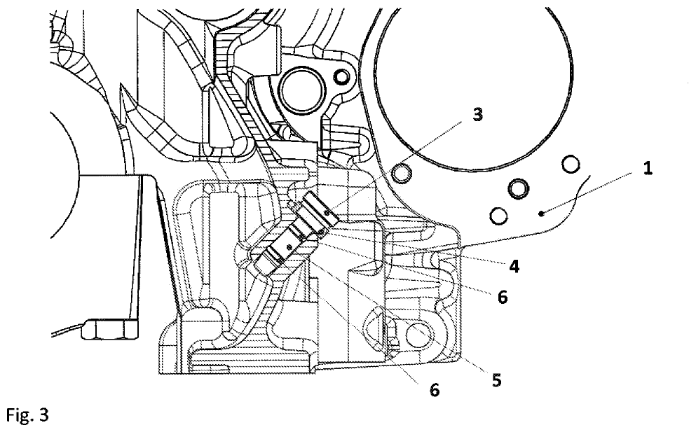

The principle of fixing using permanent magnets is furthermore transferred to a sealing stopper for the oil dipstick bore, as is shown in FIG. 1b as well as in FIG. 3. In contrast to oil dipsticks, merely dipstick 7 is omitted. Head of stopper 3 may have, as illustrated, a different design, for example a planar surface perpendicular to the longitudinal axis.

### LIST OF REFERENCE NUMERALS

1 crankcase
2 dipstick head including ring-shaped element
3 head of the stopper
4 permanent magnet
5 cylindrical part of the stopper
6 one or multiple O-ring(s) upstream and downstream from the cylindrical part of the stopper
7 dipstick having minimum and maximum markings
10 dipstick assembly
12 stopper
14 ring grooves
15 dipstick head
16 internal combustion engine
18 cylinder head
20 oil pan
22 reception element

What is claimed is:

1. An internal combustion engine comprising:
a crankcase;
a cylinder head;
an oil pan;
a stopper; and
a reception element for receiving the stopper.

2. The internal combustion engine as recited in claim 1, further a dipstick is situated at the stopper.

3. The internal combustion engine as recited in claim 1, wherein the stopper is configured to be insertable into and fixed at the reception element.

4. The internal combustion engine as recited in claim 1, wherein the stopper includes a cylindrical part having at least one ring groove for receiving an O-ring.

5. The internal combustion engine as recited in as recited in claim 1, wherein O-rings are situated upstream and downstream from a cylindrical part of the stopper.

6. The internal combustion engine as recited in as recited in claim 1, wherein a head of the stopper has a circular shape.

7. The internal combustion engine as recited in as recited in claim 1, wherein a head of the stopper is provided with a dipstick head having a ring-shaped element.

8. The internal combustion engine as recited in as recited in claim 1, further comprising a permanent magnet situated downstream from a head of the stopper.

9. A method for assembly an internal combustion engine comprising:
providing dipstick assembly including a dipstick, a stopper connected to the dipstick and a permanent magnet connected to the stopper; and
fastening the dipstick assembly to a crankcase via the permanent magnet.

10. An internal combustion engine comprising:
a crankcase; and
dipstick assembly including a dipstick, a stopper connected to the dipstick and a permanent magnet connected to the stopper, the permanent magnet fastening the dipstick assembly to the crankcase.
